(19) United States
(12) Patent Application Publication
(10) Pub. No.: US 2004/0229193 A1
(43) Pub. Date: Nov. 18, 2004

(54) Coloring paper having adhesive

(76) Inventors: Larry Wittmeyer JR., Lake Lotawana, MO (US); Lance M. Sparks, Topeka, KS (US)

Correspondence Address: STINSON MORRISON HECKER LLP, ATTN: PATENT GROUP, 1201 WALNUT STREET, SUITE 2800, KANSAS CITY, MO, 64106-2150, US

(21) Appl. No.: 10/438,227

(22) Filed: May 14, 2003

(51) Int. Cl. G09B 11/10

(52) U.S. Cl. 434/84

(57) ABSTRACT

A coloring book and coloring roll having a coloring sheet with a printed image on one surface and an adhesive, such as a repositionable pressure sensitive, on an opposing or same surface is provided.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention is directed to coloring sheets, and is more particularly directed to coloring sheets that may be incorporated into bound coloring books or coloring rolls, wherein the sheets have a printed coloring image on the top surface and an adhesive on the bottom surface to enhance use and display of the sheets.

### DESCRIPTION OF RELATED ART

Various products including coloring books and paint-by-number drawings have printed images on a substrate with specific areas intended to be colored or painted by the user. Coloring books have traditionally been printed on thin paper stock with a plurality of pages bound or stapled together to form a book. A problem arises in that such coloring books do not readily lend themselves to subsequent display of the child's work. While it is possible to remove individual sheets from the coloring book either before or after the sheets are colored, the sheets are often undesirably torn during the removal process. Moreover, it is often difficult to display the artwork without either blocking a portion of the artwork on display (such as with magnets) or permanently damaging the artwork (such as with tacks or tape).

In recent years, so called “coloring desks” adapted to receive and hold rolls of coloring paper have been developed. Examples of such coloring desks include those manufactured by Wrebbit (e.g., the Cailou Refillable Coloring Desk), Family On Board (e.g., Color 'n Roll® Coloring Desk), Tara Toys (e.g., the Barbie Rolling Art Desk), and Colorama creations (e.g., the Rolocolor Coloring Desk). The coloring roll usually has a series of printed images for coloring or painting. During use, the coloring paper from the coloring roll is mounted on a planar coloring surface of the desk by threading the paper through one or more openings in the desk or by a retaining bar. After the child has colored the printed image, the colored image is removed by tearing it from the roll, and a new uncolored image is placed on the planar coloring surface. While these coloring desks and rolls are useful, since the paper is not affixed directly to the planar coloring surface, it frequently slips and moves as the child is coloring. It is also difficult to remove the artwork without unsightly rips or tears, and the artwork is not easily displayed after removal as described above.

### BRIEF SUMMARY OF THE INVENTION

An object of the present invention is to provide a coloring sheet that can be easily adhered to another surface, such as a wall or refrigerator, for viewing.

Another object of the present invention is to provide a coloring book that has pages that can be easily removed and adhered to a surface.

Still yet another object of the present invention is to provide a coloring roll for use in a coloring desk which substantially prevents the paper from undesirably moving on the desk when the paper is being colored.

A further object is to provide a coloring roll for use in a coloring desk in which the colored images can be removed and adhered to another surface.

The present invention is directed to a coloring sheet comprising a printed coloring image on the top surface and an adhesive on the bottom surface. The coloring sheet may be incorporated within a bound coloring book or may comprise a continuous coloring roll for use with coloring desk assemblies. The adhesive may comprise any suitable adhesive for purposes of affixing the sheet to a substrate such as a wall, refrigerator or desk, and is preferably a repositionable pressure sensitive adhesive that enables the sheet to adhere to a substrate temporarily until removed by pulling. The sheet may include a coating on the top and/or bottom surfaces to improve the characteristics of the sheet, the coloring image and/or the adhesive. In a preferred embodiment, the sheet also includes a separation line, such as a perforation line, to enable a portion of the sheet to be removed from the bound coloring book or coloring roll without undesirable rips or tears. The sheet may also include coloring stickers comprising a sticker image circumscribed by a separation line on the top surface of the sheet and an adhesive on the bottom surface of the sheet opposite the sticker image.

### BRIEF DESCRIPTION OF THE DRAWINGS

FIG. 1 is a perspective view of a coloring book in accordance with a preferred embodiment of the present invention with the top cover raised.

FIG. 2A is a top plan view of a coloring sheet in accordance with a preferred embodiment of the present invention.

FIG. 2B is a bottom plan view of the coloring sheet shown in FIG. 2A.

FIG. 2C is a cross-section of the coloring sheet shown in FIG. 2A taken through line 2-2 showing a primer coating and release coating on the coloring sheet.

FIG. 2D is a cross-section of an alternative embodiment of the coloring sheet shown in FIG. 2A taken through line 2-2 showing a release strip on the coloring sheet.

FIG. 3A is a perspective view of another embodiment of a coloring book in accordance with the present invention.

FIG. 3B is a bottom plan view of a coloring sheet incorporated into the coloring book shown in FIG. 3A.

FIG. 3C is a perspective view of the coloring sheets shown in FIGS. 3A and 3B being inserted into a folded cover to form a coloring book.

FIG. 4A is a top plan view of a coloring sheet in accordance with another embodiment of the present invention.

FIG. 4B is a bottom plan view of the coloring sheet shown in FIG. 4A.

FIG. 4C is a side view of the coloring sheet shown in FIG. 4A.

FIG. 4D is a cross-section of the coloring sheet shown in FIG. 4A taken through line 4D-4D.

FIG. 5A is a top plan view of an unassembled coloring sheet prior to folding in accordance with another embodiment of the present invention.

FIG. 5B is a bottom plan view of the coloring sheet shown in FIG. 5A.

FIG. 5C is a side view of the coloring sheet shown in FIG. 5A illustrating how the folded portion is folded on the bottom surface of the sheet during assembly.

FIG. 5D is an enlarged view of a portion of the coloring sheet shown in FIG. 5C.

FIG. 5E is a top plan view of the coloring sheet shown in FIG. 5A after folding along the fold line.

FIG. 5F is a bottom plan view of the coloring sheet shown in FIG. 5A after folding.

FIG. 6A is a perspective view of a coloring desk and coloring roll assembly in accordance with a preferred embodiment of the present invention.

FIG. 6B is an exploded view of the coloring desk and coloring roll assembly illustrated in FIG. 6A showing the placement of the roll in the desk.

FIG. 6C is a bottom perspective view of the coloring roll of the present invention that is utilized with the coloring desk shown in FIG. 6A.

### DETAILED DESCRIPTION OF THE PREFERRED EMBODIMENTS

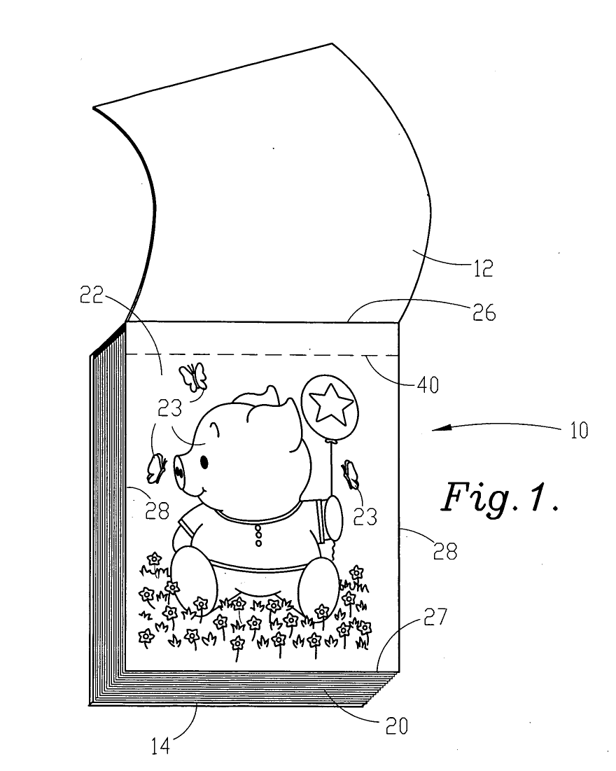

Referring to the drawings, a coloring book made in accordance with the present invention is represented generally by the numeral 10 in FIG. 1. Coloring book 10 comprises a plurality of flat, planar coloring sheets 20 having a coloring image 23 on at least one surface. Sheets 20 may be formed of any suitable material for purposes of coloring and preferably comprise paper or other cellulose based materials. For purposes of this invention, “coloring” shall encompass applying colors and/or graphics using any variety of means including crayons, paints, chalk, colored pencils, charcoal and stickers. Sheets 20 are bound to one another along a margin, preferably the top margin 26, to form a pad. Coloring book 10 also includes a top cover 12 and bottom cover 14. Staples, adhesive, fasteners, or other book binding methods well known to those skilled in the art are used to secure the sheets to one another along the margin. These binding methods are also used to secure sheets 20 to the top cover 12 and bottom cover 14 of the book 10. The coloring sheets and coloring book may be any suitable size or shape, but are preferably rectangular or square ranging in size from about 5 to 12 inches wide by about 8 to 20 inches long, and are more preferably about 8 inches wide by about 11 inches long.

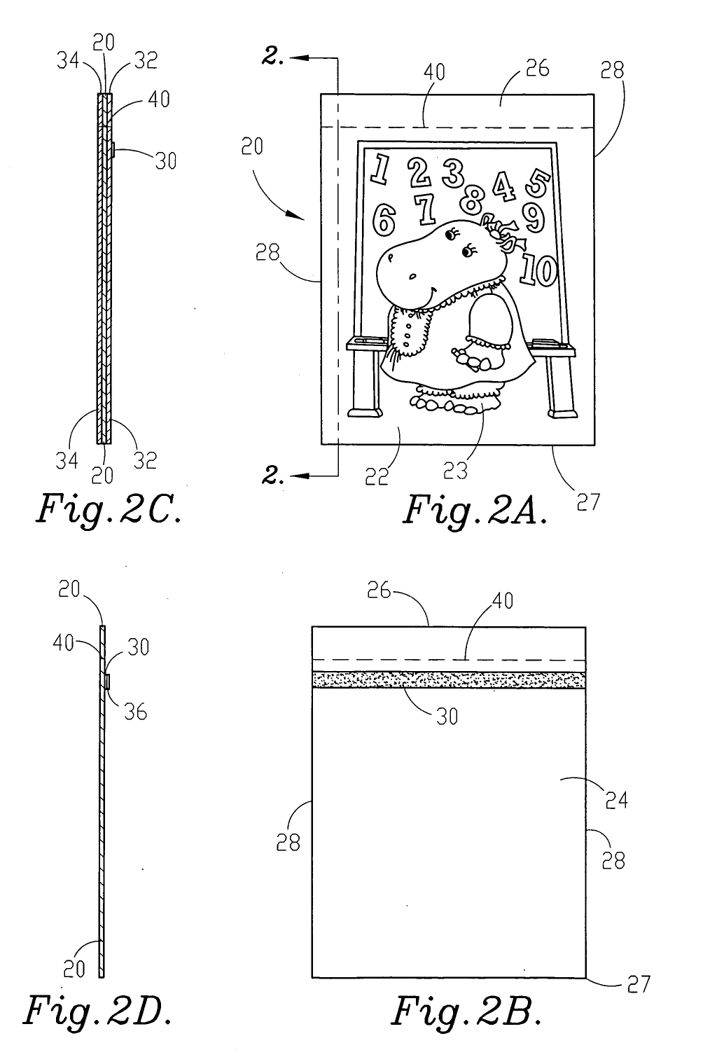

A coloring sheet 20 in accordance with a preferred embodiment of the present invention is illustrated in FIGS. 2A and 2B. Sheet 20 has a top surface 22, bottom surface 24, top margin 26, bottom margin 27, and two side margins 28. A coloring image 23 is printed on the top surface 22. It will be appreciated that coloring image 23 may be of any desirable or fashionable form (such as a tree, rabbit, Power Ranger®, or Pokemon® character). It will also be appreciated that the coloring image may include both solid outlined images (such as those shown in FIG. 2A), color-by-number, or paint-by-number images. Furthermore, the coloring image may comprise lines that are substantially visually imperceptible when viewing the coloring surface at a non-coloring distance as disclosed in Applicant's co-pending application entitled “Coloring Paper” Serial No. ______ filed on the same date as this application, which application is incorporated herein by reference. In addition, coloring images in which the image is “colored” by placing an adhesive sticker having a desired design or color onto the sheet as outlined by coloring image 23 are within the scope of the present invention.

As shown in FIG. 2B, an adhesive 30 is permanently adhered along at least a portion of the bottom surface 24 of sheet 20. Adhesive 30 is preferably in the form of a strip near or adjacent the bound margin 26 of sheet 20, but may be applied to the bottom surface of the sheet in any form and on any one or more locations. Alternatively, the adhesive may be applied on the top surface 22 of the sheet 20 having the image 23 thereon. In such an embodiment, the image 23 is well suited to be viewed through a substantially transparent surface, such as a window, by adhering the surface containing the image 23 to the window and then viewing through the opposite side. In yet another embodiment, the adhesive 30 may be applied to both the top surface 22 and bottom surface 24 of the sheet.

It will be appreciated by those in the art that it may be desirable to coat one or more surfaces of sheet 20 or portions thereof with various coatings to improve the characteristics of sheet 20, the coloring image 23 or the adhesive 30. Furthermore, sheet 20 may comprise a laminate or multiple layers of material. For purposes of this invention, the coloring image is “on” the top surface 22 of sheet 20 either by printing directly on the sheet or indirectly in or on coatings or top layers on the top surface. Similarly, the adhesive is “on” the bottom surface by application directly on the bottom surface 24 of sheet 20 or indirectly on the bottom surface such as by adherence to a bottom surface coating or bottom layer.

To facilitate removal of sheet 20 from coloring book 10, a separation line 40 is disposed on each sheet at a suitable location. The separation line may be formed by any means known in the art to enable the portion of sheet below line 40 to be separated or divided from the portion of sheet above line 40 in a relatively easy manner and straight line. Preferably, separation line 40 is formed by perforations, or via die cut or laser cut lines of weakness as is known in the art. Separation line 40 is preferably located between bound margin 26 and at least a portion of adhesive 30. Thus, a portion of sheet 20 can easily be removed from book 10 along the separation line without unsightly tears or rips. Furthermore, the removed portion of sheet 20 can be adhered to another supporting surface, such as a wall or a refrigerator via adhesive 30. It is contemplated that adhesive 30 will be located in sufficient quantities and locations such that the removed portion of sheet 20 is capable of adhering to a display surface, like a refrigerator.

Adhesive 30 may be any adhesive known in the art capable of adhering the removed portion of sheet 20 to a substrate such as a desk, wall or refrigerator, including hot melt, fugitive (e.g. “lick & stick”), or repositional pressure sensitive adhesive. Preferably, the adhesive is a repositional pressure sensitive adhesive. The term “repositional pressure sensitive adhesive” as used herein means adhesive that remains permanently adhered to sheet 20 but which adheres only temporarily when pressed to a supporting surface and is readily releasable therefrom upon pulling of the sheet away from the supporting surface. Preferably, such an adhesive should be waterproof, odorless, and nontoxic.

Numerous products using repositional pressure sensitive adhesive are commercially available, as are the adhesive compositions themselves. One preferred type of repostional pressure sensitive adhesive is a repositionable microsphere pressure-sensitive adhesive as described in U.S. Pat. Nos. 5,045,569; 4,495,318; 4,166,152; 3,857,731; 3,691,140; US Re 24906; U.S. Pat. No. 5,571,617 and EP-A-0 439 941. Suitable microsphere adhesives are manufactured by National Starch, Franklin Adhesives, and Advanced Polymer International (e.g. GEL-TAC®). A preferred adhesive is manufactured by Advanced Polymer International and commercially available from Craig Adhesives & Coatings (Newark, N.J.) as Product No. 3991PI.

FIGS. 2C and 2D show alternative embodiments of the coloring sheet shown in FIG. 2A. The thickness of the sheet and coatings are not shown to scale in FIGS. 2C and 2D for illustrative purposes only. Other cross-sections and side views shown herein are likewise enlarged.

It will be appreciated by those in the art that when using a microsphere repositional pressure sensitive adhesive, sheet 20 will preferably be coated on at least a portion of one surface with a primer coating and on at least a portion of the other surface with a release coating. In the embodiment shown in FIG. 2C, primer coating 32 is disposed on the bottom surface 24 of sheet 20, and adhesive 30 is adhered to primer coating 32. This primer coating assists in maintaining the adhesive adhered to the sheet. Release coating 34 is disposed on the top surface 22 of sheet 20 and image 23 is printed on top of or beneath the release coating 34 (e.g., image-release coating-paper or release coating-image-paper). The release coating enables the adhesive of an overlying sheet to be more easily released from sheet 20 when a portion of the overlying sheet is removed from the coloring book. The release coating 34 also helps prevent the printed image from bleeding as is known in the art.

It should be understood that while primer coating 32 is shown to cover the entire bottom surface 24, it may be provided only on those portions of the sheet corresponding with adhesive 30. Suitable primer coatings are well known to those skilled in the art, and include those referenced in Pierre, U.S. Pat. No. 5,958,135. A preferred primer coating is commercially available from Craig Adhesive & Coatings (Newark, N.J.) as Product No. 3991PR.

Similarly, while the release coating 34 preferably covers the entire top surface 22 of sheet 20 so that the top surface has a uniform appearance, it may be included only on those portions of the sheet corresponding with adhesive 30 presented on the bottom surface of an overlying sheet. Suitable release coatings are well known to those skilled in the art, and include silicones, acrylates, chrome complexes, urethanes, and fluorochemicals. The preferred release coating is commercially available from Craig Adhesive & Coatings (Newark, N.J.) as Product No. 6960SIHV.

Alternatively, sheet 20 may have a release strip 36 releasably affixed to adhesive 30 to protect the adhesive and prevent it from sticking to the underlying sheet as illustrated in FIG. 2D. Release strip 36 typically has a size and configuration corresponding with adhesive 30. The release strip 36 is comprised of any suitable material, such as paper, film, or foil. The release strip is preferably comprised of twenty-four pound bond paper or equivalent film, and has a thickness of approximately 3/1000 to 7/1000 inch and even more preferably about 3.5/1000 inch. During use, the release strip 36 is removed to expose adhesive 30 such that the sheet 20 can be adhered to another supporting surface.

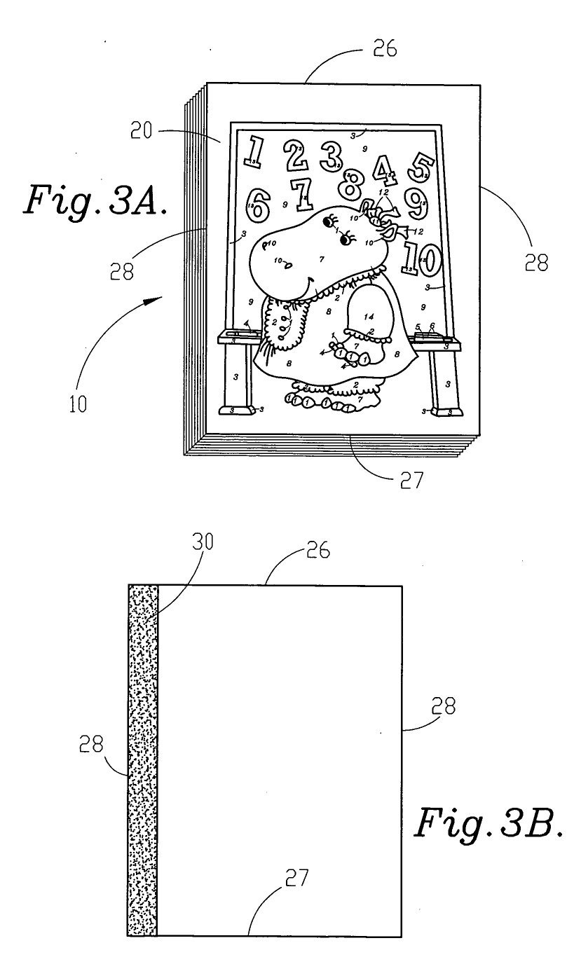

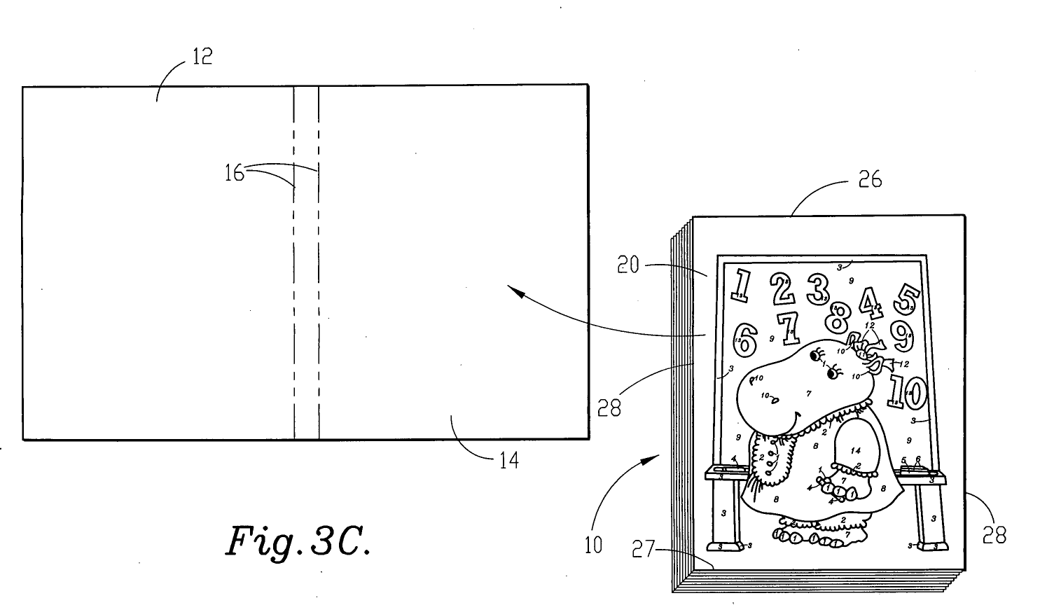

Another embodiment of a coloring sheet 20 in accordance with the present invention is shown in FIGS. 3A and 3B. In this embodiment, coloring sheets 20 are incorporated into a coloring book 10 that has no top cover or bottom cover. Each coloring sheet comprises a coloring image 23 on the top surface 22 of the sheet. Image 23 shown in FIG. 3A incorporates numbers so that the user can paint or color-by-number. Sheets 20 are bound along a side margin 28 using repositional pressure sensitive adhesive 30 positioned directly adjacent side margin 28. There is no separation line along the bound margin. The coloring sheets 20 can easily be removed from the coloring book 10 before or after the image 23 has been colored since book 10 is bound using the repositional pressure sensitive adhesive 30. The removed portion of the sheet can also easily be adhered to a suitable surface for display via adhesive 30 upon removal from the book.

Coloring sheets 20 illustrated in FIGS. 3A and 3B may be utilized with a bottom and optionally top cover. For example, although not illustrated in the drawings, a bottom cover corresponding in size and shape to the sheets 20 could be adhered to the bottom-most sheet 20 of the pad using the adhesive 30 on the bottom-most sheet. Alternatively, as shown in FIG. 3C, a bottom cover 14 and top cover 12 could be formed of a unitary piece of cover material by creating one or more fold lines 16 to define a spine. The pad may be adhered to the bottom cover 14 via adhesive 30 on the bottom-most sheet 20 and the top cover 12 may be simply folded over the top-most sheet 20. Alternatively, the adhesive 30 on the bottom-most sheet 20 may be covered by a release strip 36, and the pad may be fastened to the cover using staples, adhesives, fasteners, or other book binding methods well known to those skilled in the art. It will be appreciated that such a cover can be sized and folded if the sheets 20 are bound along a side margin (as shown in FIG. 3C) or along a top margin (not shown).

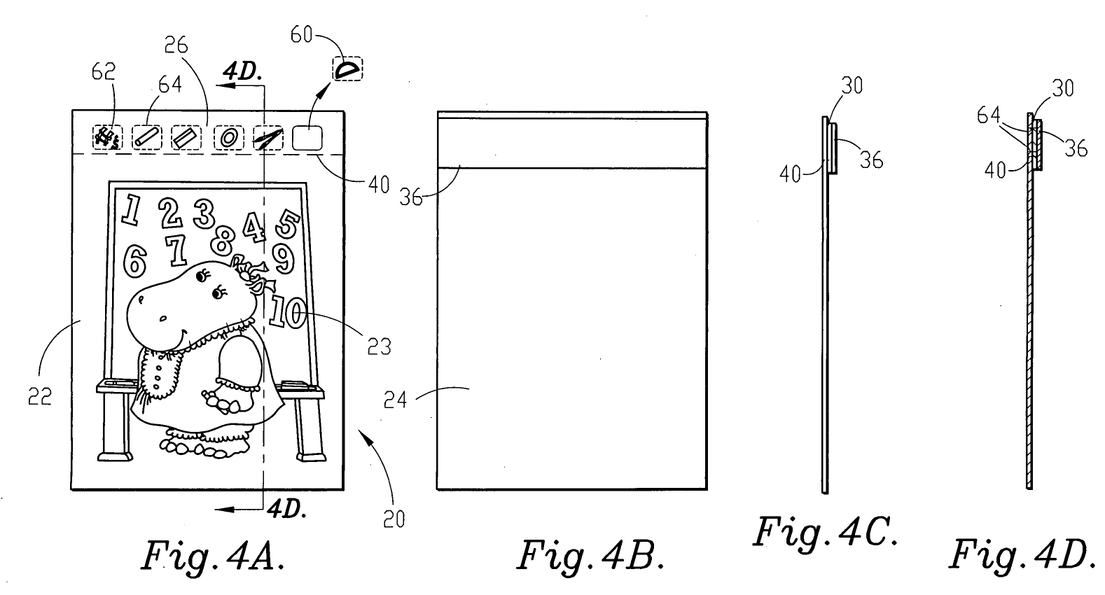

Another embodiment of a coloring sheet 20 in accordance with the present invention is shown in FIGS. 4A through 4D. In this embodiment, adhesive 30 is used to create removable stickers 60 in sheet 20. More specifically, as shown in FIG. 4A, sheet 20 has a top surface 22 with a coloring image 23 thereon and one or more sticker images 62 thereon. Sticker images 62 may be pre-colored, color-by-number, paint-by-number, or in printed outline form. The sticker images 62 are preferably located adjacent one margin, preferably the bound margin and most preferably immediately below the top margin 26. A sticker separation line 64 circumscribes each of the sticker images 62 so that the stickers can be removed from sheet 20. Sticker separation line 64 may be formed by any means known in the art to enable the sticker to be separated from the remainder of the sheet in a relatively easy manner and clean line. Preferably the separation line is formed by perforations, or via die cut or laser cut lines of weakness as is known in the art. Adhesive 30 is coated on the bottom surface 24 of sheet 20 opposite at least a portion of each sticker image 62. The adhesive is preferably formed in a strip opposite a plurality of sticker images 62 and is preferably covered by a release strip 36 as shown in FIGS. 4B and 4C. When a sticker image 62 circumscribed by the sticker separation line 64 is removed from sheet 20 and release strip 36, a removable sticker 60 is formed.

As shown in FIG. 4A, to facilitate removal of a portion of sheet 20 from the pad of sheets 20 and/or the sticker images 62, a separation line 40 as previously described is also disposed on each sheet at a suitable location. Looking to FIGS. 4C and 4D, separation line 40 is preferably disposed within the strip of adhesive 30. Thus, when sheet 20 is torn at separation line 40, some of the adhesive 30 remains on the removed portion of sheet 20 so that it can be adhered to another supporting surface. Some of adhesive 30 also remains opposite the sticker images 62 as discussed above.

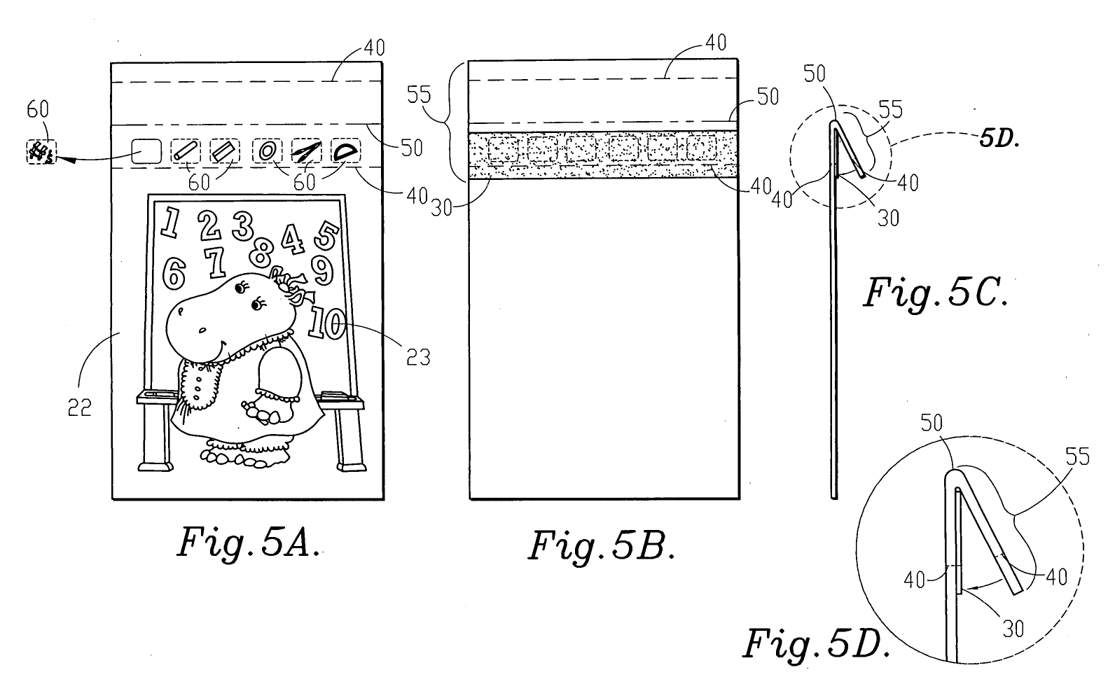

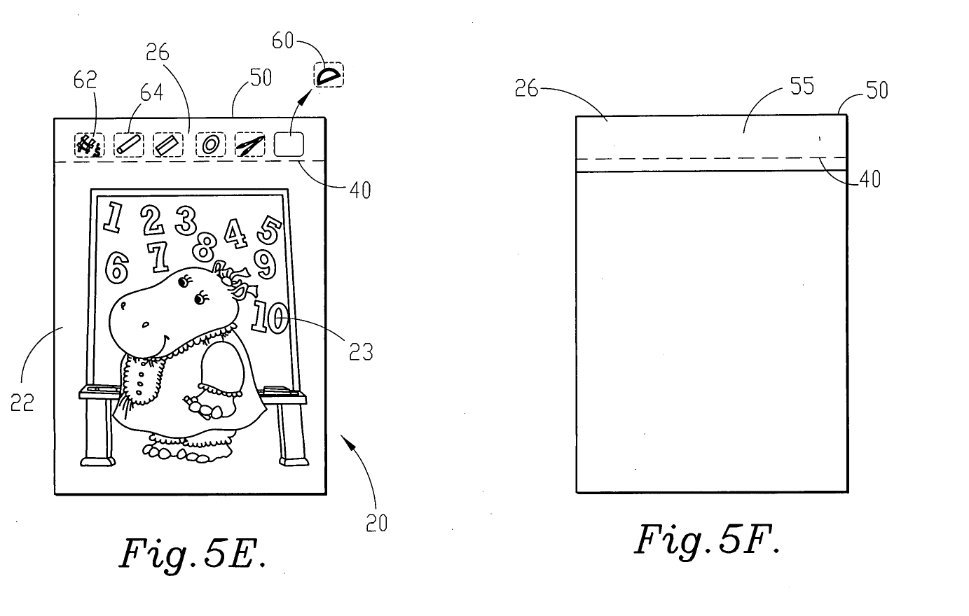

Yet another embodiment of the coloring sheet in accordance with the present invention is shown in FIGS. 5A through 5F. In contrast to the prior embodiments, the coloring sheet 20 of this embodiment utilizes a folded portion of sheet 20 as a release strip. More specifically, as shown in FIGS. 5A and 5B, sheet 20 includes removable stickers 60 as discussed above with adhesive 30 on the bottom surface 24 of the sheet 20. As illustrated in FIG. 5C and in more detail in FIG. 5D, sheet 20 is folded at a folding line 50 so that folded portion 55 is disposed over at least a portion, and preferably all, the adhesive 30. As a result, adhesive 30 is positioned between the bottom surface 24 of sheet 20 and folded portion 55 such that the folded portion functions as a release strip. Once folded, the top and bottom of the sheet appears as illustrated in FIGS. 5E and 5F, respectively, wherein fold line 50 is the upper margin of sheet 20.

Looking to FIGS. 5E and 5F, separation line 40 is also preferably disposed through sheet 20 and folded portion 55 to facilitate removal of a portion of the sheet 20 from a pad of sheets 20 and/or removal from that portion of the sheet having stickers 60. Separation line 40 is preferably disposed within the strip of adhesive 30 such that when the sheet 20 is torn at the separation line 40, some of adhesive 30 remains on the removed portion of sheet 20 so that it can be adhered to another supporting surface. Some of adhesive 30 also remains opposite the sticker images 60. The coloring sheet 20 of this embodiment may be bound into a coloring book along the top margin 26 using means well known to those skilled in the art.

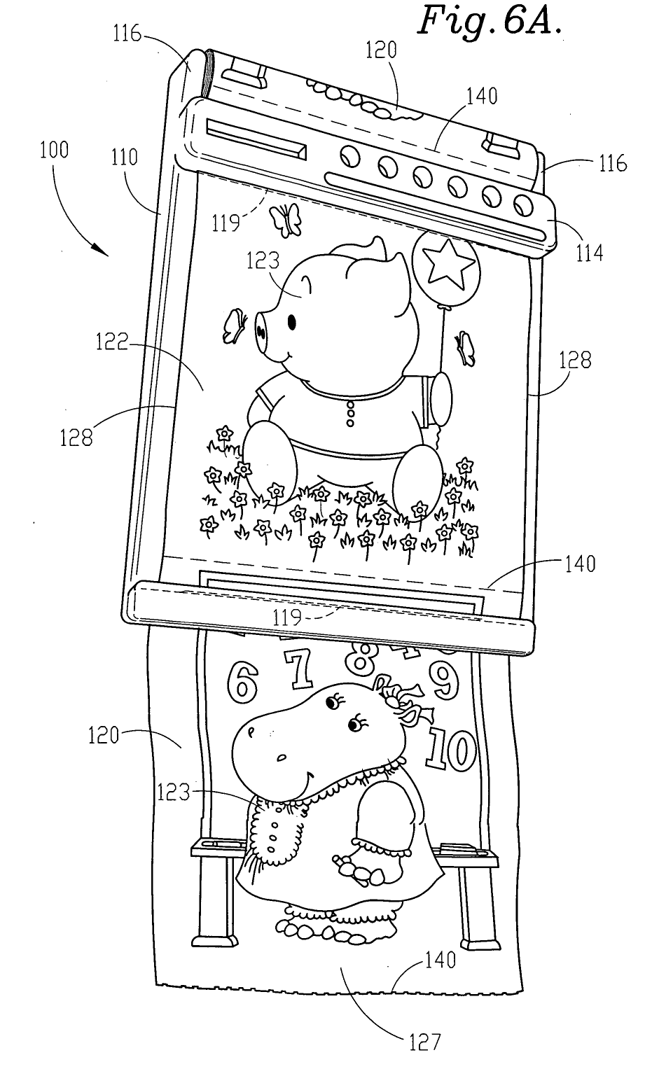

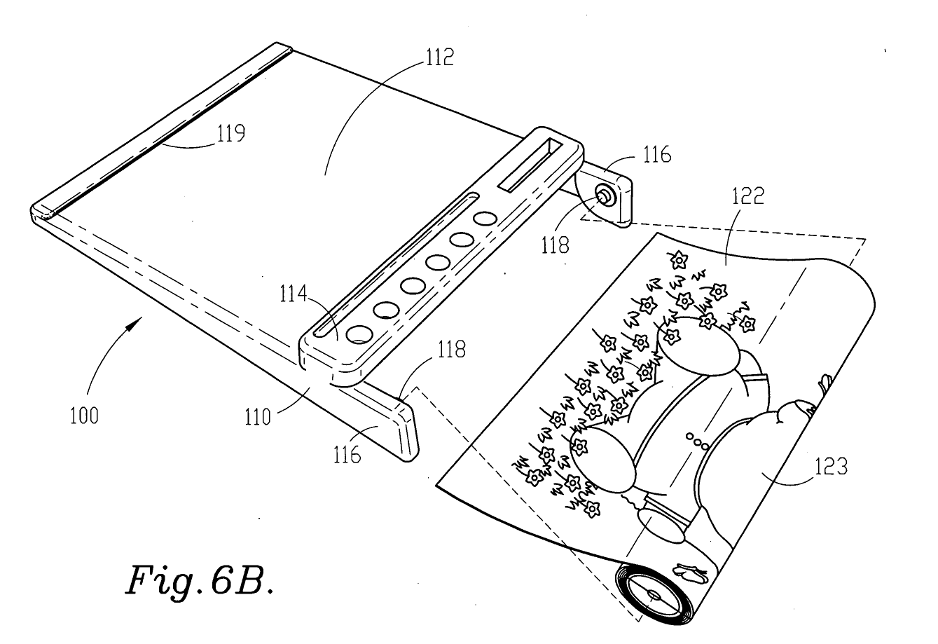

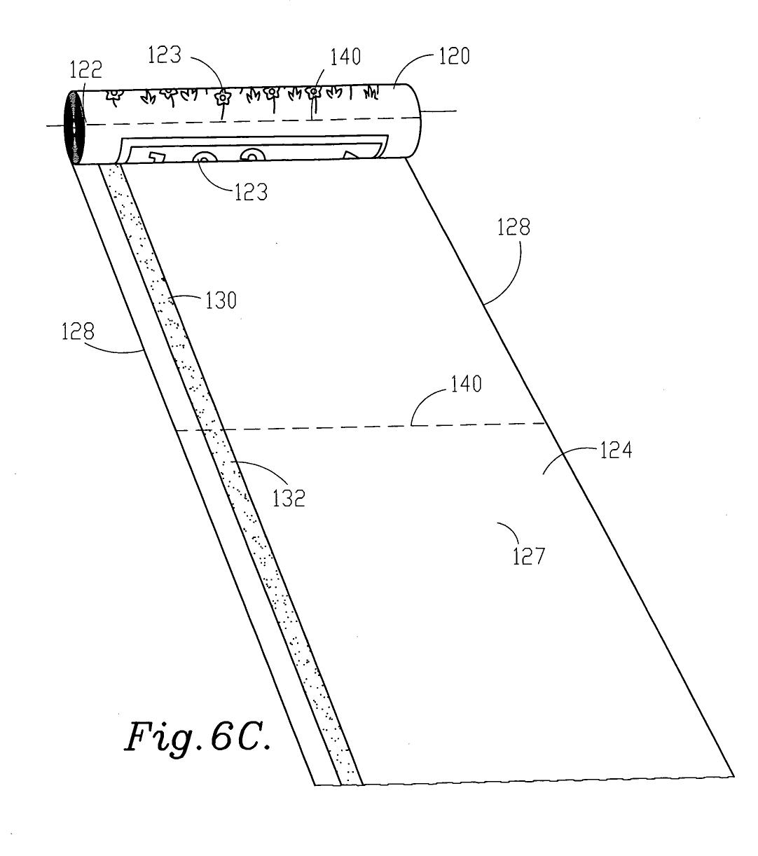

Still yet another embodiment of a coloring sheet in accordance with the present invention is shown in FIGS. 6A through 6C. In this embodiment, the coloring sheet is in the form of a roll 120 for use in a coloring desk and roll assembly 100. Roll 120 is a roll of sheet like material suitable for coloring and preferably comprises a roll of paper or other cellulose based materials. The roll may be coated to enhance the use of the roll, the coloring image, and/or the adhesive. Roll 120 has one or a series of printed coloring images 123 thereon. As previously discussed, various types of coloring images are within the scope of the present invention.

The exemplary coloring desk 110 shown in FIGS. 6A and 6B is manufactured by Rose Art Industries., Inc, but those skilled in the art will recognize that various other desks may be used with the coloring roll of the present invention. The portable desk 110 includes a substantially planar coloring surface 112, a coloring instrument organizer 114, and at least one coloring roll receiving portion 116. The coloring roll receiving portion 116 includes two projections 118 which extend from the inner surface of the sides of the desk 110. These projections 118 removably engage the coloring roll so that a portion of the roll can be dispensed onto the coloring surface 112 through one or more openings 119 as desired.

The coloring roll 120 of the present invention is illustrated in FIG. 6C. Roll 120 has a top surface 122, bottom surface 124, bottom margin 127, and two side margins 128. The coloring roll preferably has a length of about 12 to 40 feet, more preferably about 16 to 20 feet, and a width of about 4 to 16 inches, more preferably about 11 inches. The coloring image 123 may be one long continuous image or a series of separate periodically spaced images.

As shown in FIG. 6C, an adhesive 130, preferably repositional pressure sensitive adhesive, is permanently applied along the bottom surface 124 of the roll, preferably in the form of a strip adjacent at least one of the side margins 128. Thus, the adhesive can be used to removably secure a portion of the roll to the planar coloring surface 112 of the coloring desk so that it does not undesirably move when the image 123 thereon is being colored. In addition, the adhesive enables that portion of the roll with the colored image 123 thereon to removably adhere to another surface for display of the colored artwork upon removal from the roll. It will be appreciated that the adhesive may alternately be applied to at least a portion of the top surface or to both the bottom and top surface as discussed above.

To facilitate removal of a portion of the roll 120, separation lines 140 as heretofore described are periodically disposed along the roll 120. The separation lines 140 extend between the two side margins 128 and are preferably located between each of the series of printed coloring images 123 (e.g., between the hippopotamus and pig printed coloring images shown in FIG. 6A). Thus, each printed image can be removed from the roll and adhered to another supporting surface, such as a wall or refrigerator.

In yet another embodiment (not shown), a drawing book is provided. The drawing book comprises a plurality of sheets bound along one margin to form a pad. Each drawing sheet has an adhesive (preferably a repositional pressure sensitive adhesive) on at least one surface (preferably in a strip along a margin of the pad). In this embodiment, the drawing sheets are manufactured without a coloring image 23 thereon and secured to a top cover 12 and/or bottom cover 14. The drawing pad may be any suitable shape or size, but is preferably about 8×11 inches.

While specific embodiments have been shown and discussed, various modifications may of course be made, and the invention is not limited to the specific forms or arrangement of parts and steps described herein, except insofar as such limitations are included in the following claims. For example, those skilled in the art will recognize that any suitable adhesive may be used in accordance with the present invention with or without primer coatings, release coatings, or release strips. In addition, those skilled in the art will appreciate that the adhesive could be located at any suitable location on the opposite side of the printed coloring image (e.g. along one side margin, both side margins, extending between the side margins, in a continuous strip, at the corners of each strip, at a center spot, etc.). As another example, the coloring roll of the present invention can be utilized with any suitable coloring desk known to those skilled in the art with a roll receiving portion, such as one having a bar that extends inside the coloring roll. Likewise, those skilled in the art will recognize that the stickers described in FIGS. 4A-5F, are well adapted to be utilized with a coloring roll, as well as a coloring sheet. Further, it will be understood that certain features and sub-combinations are of utility and may be employed without reference to other features and sub-combinations. This is contemplated by and is within the scope of the claims.

1. A coloring sheet having a top surface and a bottom surface, said top surface having a printed coloring image for coloring on said top surface and said bottom surface having a repositional pressure sensitive adhesive on said bottom surface.

2. The coloring sheet of claim 1 wherein said sheet is comprised of paper.

3. The coloring sheet of claim 1 wherein said adhesive is disposed adjacent at least one margin of said bottom surface of said sheet.

4. The coloring sheet of claim 3 wherein said adhesive is in the form of a strip of adhesive.

5. The coloring sheet of claim 4 wherein said adhesive is adjacent a top margin of said sheet.

6. The coloring sheet of claim 1 wherein said coloring image is selected from the group consisting of a solid outlined image, a paint-by-number image, and a color-by-number image.

7. The coloring sheet of claim 2 wherein a primer coating resides between at least a portion of said bottom surface of the coloring sheet and the adhesive.

8. The coloring sheet of claim 7 wherein said primer resides on substantially the entire bottom surface of the coloring sheet.

9. The coloring sheet of claim 1 wherein a release coating resides on at least a portion of said top surface of said coloring sheet, and said coloring image is disposed above said release coating.

10. The coloring sheet of claim 9 wherein said release coating resides on substantially the entire top surface of the coloring sheet.

11. The coloring sheet of claim 1 wherein a release strip is removably affixed to at least a portion of said adhesive.

12. The coloring sheet of claim 11 wherein said release strip overlies substantially all of said adhesive on said bottom surface, and said release strip is comprised of paper.

13. The coloring sheet of claim 1 further comprising a sticker in said sheet.

14. The coloring sheet of claim 13 wherein said sticker comprises a sticker image on said top surface of said sheet, and wherein said adhesive is on said bottom surface of said sheet opposite said sticker image, and wherein said sticker image is circumscribed by a separation line.

15. The coloring sheet of claim 13 further comprising a release strip releasably affixed to said adhesive opposite said sticker image.

16. The coloring sheet of claim 15 wherein said release strip comprises a folded portion of said sheet.

17. The coloring sheet of claim 1 when said coloring sheet also has a repositional pressure sensitive adhesive on said top surface.

18. The coloring sheet of claim 1 when said bottom surface also has a printed coloring image for coloring thereon.

19. A coloring book comprising:
a plurality of coloring sheets bound along a margin to form a pad,
wherein each of said coloring sheets has a top surface, a bottom surface, a top margin, a bottom margin, and two side margins; and
wherein at least one sheet has a printed coloring image for coloring on its top surface and an adhesive on its bottom surface.

20. The coloring book of claim 19 wherein said adhesive is a repositional pressure sensitive adhesive.

21. The coloring book of claim 20 wherein each sheet has a printed coloring image on its top surface and repositional pressure sensitive adhesive on its bottom surface.

22. The coloring book of claim 19 wherein said coloring book further comprises a top cover and a bottom cover covering said pad.

23. The coloring book of claim 22 wherein said pad is affixed to said bottom cover using a strip of adhesive on a bottom sheet of said pad.

24. The coloring book of claim 22 wherein said pad has adhesive on the bottom surface of a bottom-most sheet of said pad, and wherein said adhesive is covered by a release strip.

25. The coloring book of claim 19 wherein said at least one sheet has a printed coloring image on its bottom surface.

26. The coloring book of claim 25 wherein said top cover and said bottom cover are formed by folding a unitary covering along at least one fold line.

27. The coloring book of claim 19 wherein said adhesive is in the form of a strip of adhesive.

28. The coloring book of claim 19 wherein said adhesive is adjacent the top margin of the sheet, and said pad is bound along the top margin.

29. The coloring book of claim 19 wherein said at least one sheet has a separation line.

30. The coloring book of claim 29 wherein each sheet has a separation line.

31. The coloring book of claim 30 wherein the separation line on each sheet is located between the bound margin of each sheet and the adhesive such that when a sheet is separated from the pad via the separation line, adhesive remains on the separated sheet.

32. The coloring book of claim 19 wherein said printed coloring image is selected from the group consisting of a solid outlined image, a paint-by-number image, and a color-by-number image.

33. The coloring book of claim 19 wherein a primer coating resides between at least a portion of said bottom surface of said coloring sheet and the adhesive thereon.

34. The coloring book of claim 33 wherein said primer coating resides on substantially the entire bottom surface of the coloring sheet.

35. The coloring book of claim 19 wherein a release coating resides on at least a portion of said top surface of said coloring sheet, and said printed coloring image is disposed above said release coating.

36. The coloring book of claim 35 wherein said release coating resides on substantially the entire top surface of the coloring sheet.

37. The coloring book of claim 19 wherein a release strip is removably affixed to at least a portion of said adhesive on said bottom surface of said coloring sheet.

38. The coloring book of claim 37 wherein said release strip overlies substantially all of said adhesive on said bottom surface, and said release strip is comprised of paper.

39. The coloring book of claim 19 further comprising a sticker in at least one said sheet.

40. The coloring book of claim 39 wherein said sticker comprises a sticker image on said top surface of said sheet, and wherein said adhesive is on said bottom surface of said sheet opposite said sticker image, and wherein said sticker image is circumscribed by a separation line.

41. The coloring book of claim 40 further comprising a release strip releasably affixed to said adhesive opposite said sticker image.

42. The coloring book of claim 41 wherein said release strip comprises a folded portion of said sheet.

43. The coloring book of claim 19 wherein at least one sheet has a printed coloring image for coloring on its top surface and a repositional pressure sensitive adhesive on its top surface.

44. A coloring roll comprising a sheet having a first surface, an opposite second surface, and two side margins, and wherein said first surface has at least one printed coloring image thereon for coloring; and
wherein said second surface has an adhesive on at least a portion of said second surface.

45. The coloring roll of claim 44 wherein said adhesive is a repositional pressure sensitive adhesive.

46. The coloring roll of claim 44 wherein said adhesive is adjacent at least one side margin of said sheet.

47. The coloring roll of claim 46 wherein said adhesive is in the form of a strip of adhesive.

48. The coloring roll of claim 44 wherein there are a series of consecutive coloring images on said first surface.

49. The coloring roll of claim 48 wherein said roll has at least one separation line extending between the two side margins to separate two consecutive coloring images in the series.

50. The coloring roll of claim 49 wherein said adhesive extends between the two side margins.

51. The coloring roll of claim 44 wherein a release strip is removably affixed to at least a portion of said adhesive.

52. The coloring roll of claim 51 wherein said release strip overlies substantially all of said adhesive, and said release strip is comprised of paper.

53. The coloring roll of claim 44 further comprising a sticker in said roll.

54. The coloring roll of claim 53 wherein said sticker comprises a sticker image on said first surface of said roll, and wherein said adhesive is on said bottom surface of said roll opposite said sticker image, and wherein said sticker image is circumscribed by a separation line.

55. The coloring roll of claim 54 further comprising a release strip releasably affixed to said adhesive opposite said sticker image.

56. The coloring roll of claim 55 wherein said release strip comprises a folded portion of said sheet.

57. The coloring roll of claim 47 wherein said first surface having said printed coloring image also has a repositional pressure sensitive adhesive thereon.

58. A coloring desk and roll assembly comprising:
a coloring desk having a substantially planar coloring surface and adapted to maintain a coloring roll; and
a coloring roll,
said coloring roll comprising a sheet having a first surface, a second opposite surface, and
two side margins,
and said coloring roll having at least one printed image for coloring on said first surface
and an adhesive on said opposite surface.

59. The coloring desk and roll assembly of claim 58 wherein said adhesive is a repositional pressure sensitive adhesive.

60. The coloring desk and roll assembly of claim 58 wherein said adhesive is adjacent at least one side margin of said sheet.

61. The coloring desk and roll assembly of claim 60 wherein said adhesive is adjacent at least one side margin in the form of a continuous strip of adhesive.

62. The coloring desk and roll assembly of claim 58 wherein said coloring image comprises a solid outlined image.

63. The coloring desk roll assembly of claim 58 wherein said coloring desk has a roll receiving portion with two projections that removably engage the coloring roll.

64. The coloring desk and roll assembly of claim 58 wherein said roll has a plurality of coloring images on said first surface, and wherein a separation line extends between the two side margins of the roll to permit the separation of two consecutive coloring images.

65. The coloring desk and roll assembly of claim 64 wherein said adhesive is in the form of a strip adjacent a side margin.

66. The coloring desk and roll assembly of claim 64 wherein said adhesive is in a strip adjacent said separation line and extends between the two side margins.

67. The coloring desk and roll assembly of claim 58 wherein a release strip is removably affixed to at least a portion of said adhesive.

68. The coloring desk and roll assembly of claim 67 wherein said release strip overlies substantially all of said adhesive, and said release strip is comprised of paper.

69. A method for displaying a coloring image comprising:
providing a coloring sheet having a first and second surface and having a repositional pressure sensitive adhesive permanently affixed on a surface and a coloring image on a surface;
coloring said coloring image; and
affixing said coloring sheet to a separate support surface for display using said adhesive on said sheet.

70. The method of claim 69 where said separate support surface is selected from the group consisting of a wall or refrigerator.

71. The method of claim 69 wherein said adhesive is on a surface opposite the coloring image.

72. The method of claim 69 wherein said adhesive is in the form of a strip along a margin.

73. The method of claim 69 wherein said coloring image is a color-by-number image.

74. The method of claim 69 wherein said sheet further comprises a separation line.

75. The method of claim 74 further comprising the step of separating said sheet at said separation line such that adhesive remains on the separated sheet having the coloring image.

76. The method of claim 75 wherein said separation line is between at least one sticker in said sheet and said coloring image.

77. The method of claim 69 wherein said coloring image and said repositional pressure sensitive adhesive is on the same surface of said sheet.

78. A drawing book comprising:
a plurality of drawing sheets bound along a margin to form a pad,
wherein each of said drawing sheets has a top surface and a bottom surface, and
wherein at least one sheet has a repositional pressure sensitive adhesive on a surface; and
a cover covering at least a portion of said pad.

79. The drawing book of claim 78 wherein said cover comprises a bottom cover covering said pad.

80. The drawing book of claim 78 wherein said pad is affixed to said cover using a strip of repositional adhesive on a sheet of said pad.

81. The drawing book of claim 79 wherein said cover also comprises a top cover, and wherever said top cover and said bottom cover are formed by folding a unitary covering along at least one fold line.

82. The drawing book of claim 78 wherein said adhesive is in the form of a strip of adhesive adjacent a margin of said at least one sheet.

83. The drawing book of claim 78 wherein said at least one sheet also has a separation line.

84. The drawing book of claim 82 wherein a release strip is removably affixed to at least a portion of said adhesive on said bottom surface of at least one said coloring sheet.

85. The drawing book of claim 78 wherein said at least one sheet has a repositional pressure sensitive adhesive on its top surface and bottom surface.
